(19) United States
(12) Patent Application Publication
(10) Pub. No.: US 2009/0271762 A1
(43) Pub. Date: Oct. 29, 2009

(54) BUSINESS SOFTWARE APPLICATION SYSTEM AND METHOD

(75) Inventors: Jacob Taylor, Santa Clara, CA (US); Lila Alexei Tretikov, Los Gatos, CA (US); Majed Itani, San Jose, CA (US); Joseph Parsons, Austin, TX (US); Travis Swicegood, Lawrence, KS (US); Matt Heitzenroder, Miami, FL (US); Andrew Wu, Sunnyvale, CA (US); Roger Smith, Morrisville, NC (US); John Mertic, Doylestown, OH (US)

Correspondence Address: DLA PIPER LLP (US ), 2000 UNIVERSITY AVENUE, EAST PALO ALTO, CA, 94303-2248, US

(73) Assignee: SugarCRM Inc., Cupertino, CA (US)

(21) Appl. No.: 12/432,086

(22) Filed: Apr. 29, 2009

Related U.S. Application Data
(60) Provisional application No. 61/048,791, filed on Apr. 29, 2008.

(51) Int. Cl. G06F 9/44; G06F 3/00

(52) U.S. Cl. 717/107; 715/700; 707/104.1; 726/5; 380/277

(57) ABSTRACT

A business software application system and method are provided.

### RELATED APPLICATIONS/PRIORITY CLAIM/CROSS REFERENCE TO RELATED APPLICATIONS

This application claims the benefit under 35 USC 119(e) to U.S. Provisional Patent Application Ser. No. 61/048,791 filed on Apr. 29, 2008 and entitled “Business Software Application System and Method”, the entirety of which is incorporated herein by reference.

### FIELD

The system and method relate generally to a business software system and method and in particular to a software-based system and method for providing customer relationship management.

### BACKGROUND

Customer relationship management (CRM) systems and solutions are well known. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These limitations have led to a failure rate of over 70% with traditional CRM implementations. Thus, it is desirable to provide a customer relationship management system and method that overcomes these limitations of typical CRM systems and it is to this end that the system and method are directed.

### SUMMARY

A business application system and method are provided that includes a number of features as set forth below in detail. In one embodiment, the business application may be software based customer relationship management system.

### BRIEF DESCRIPTION OF THE DRAWINGS

FIG. 1A is a diagram illustrating a customer relationship management system that incorporates the various features of the invention;

FIG. 1B illustrates more details of the customer relationship management system that incorporates the various features of the invention;

FIG. 2 is a diagram illustrating an example of the user interface of the system in FIGS. 1A and 1B;

FIG. 3 illustrates an application and environment resource management system;

FIG. 4 illustrates a clustered architecture of a business software application system;

FIG. 5 illustrates a workflow of a resource management method;

FIG. 6 illustrates a flowchart of the resource management method;

FIG. 7 illustrates an example of a tracker monitor class diagram of a business software application system;

FIG. 8 illustrates an example of a set of storage classes for a business software application system;

FIG. 9 illustrates a workflow of a tracker unit of a business software application system; and

FIG. 10 illustrate an example of a reports unit architecture;

FIGS. 11-17 illustrate a wireless version of the business software application system displayed on a wireless device.

### DETAILED DESCRIPTION OF ONE OR MORE EMBODIMENTS

The system and method are particularly applicable to an open source customer relationship management software system and it is in this context that the system and method will be described. It will be appreciated, however, that the algorithms, data structures, processes and modules of the system and method have greater utility since these modules, algorithms, data structures and processes disclosed herein can be equally applied to other non-open source CRM systems, as well as other business software application systems as well as other database software systems. For purposes of illustration, the described system is an implementation in a customer relationship management (CRM) and groupware system. In the example below, the CRM and groupware system is the Sugar Enterprise version 5.1 that was not yet commercially available from SugarCRM Inc. as of the filing date of the provisional patent application and is now commercially available from SugarCRM Inc.

The system may be implemented using a base class known as SugarBean, and a data retrieval API. A few of the methods provided in the base class include methods for building list queries, saving, and retrieving individual items. Each specific type of data creates a subclass of this base class. The base class is called SugarBean in the illustrative example that is described below. There is at least one subclass of SugarBean for each module. SugarBeans also are used for creating database tables, cleaning out database tables, loading records, loading lists, saving records, and maintaining relationships. One example of a SugarBean subclass is a Contact subclass. The Contact subclass is a simple object that fills in some member variables on the SugarBean and leverages SugarBean for much of its logic and functionality. For example, the security associated with the Contact subclass is automatically created for Contact by SugarBean that contains, among other things, the functions and processes that are shared by the other modules. Another example of a SugarBean subclass is Users which is a module that is security related and contains the list of users as well as users who should not have row level security (described below in more detail) applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

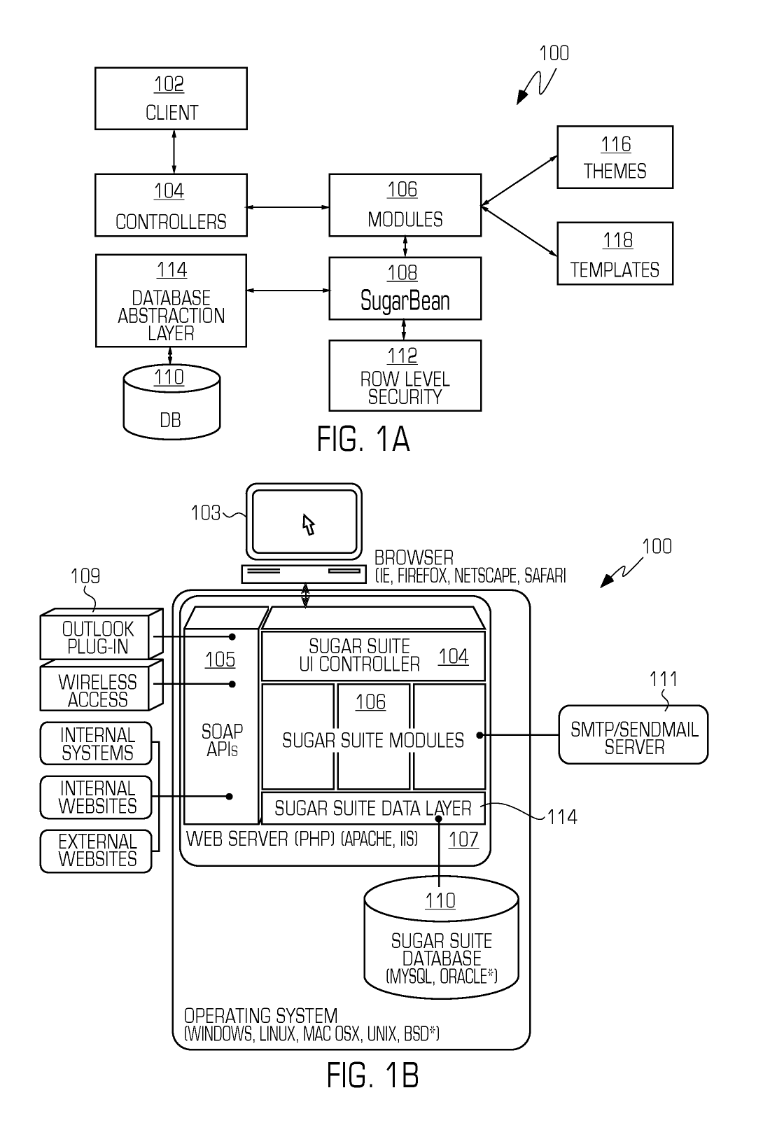

FIG. 1A is a diagram illustrating a customer relationship management (CRM) system 100 that is an example of a software-based business software application. In one embodiment, the system 100 may be implemented as a software system and the elements shown in FIGS. 1A and 1B are thus implemented as a plurality of lines of computer code that may be executed by a processor of a computer system, such as a server computer wherein the various lines of computer code are stored in a memory associated with the computer system and the system interfaces with a database 110 that stores the data associated with the system 100. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client's 102 interactions with the system are managed and go through a set of one or more controllers 104. The controllers 104 are the entry-point into the system for an entity that is using the system wherein the entity may be a person who accesses the system, such as by using a browser application, a computing device or a software program that uses this entry point. The controllers 104 take care of functions and operations including, for example, session tracking, session security and user authentication. The controllers also, for each user, prepare the screen/user interface or the wrapper for the content and determine which module of the application the user is trying to access and get the requested module to process the request.

The system has one or more modules 106 that are components of application functionality and provide certain functionality to the entity accessing the system. The modules 106 of the exemplary CRM system shown in FIG. 1A may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. The system may include different, more or fewer modules and the systems with those other combination of modules are within the scope of the system and method. Each of these modules provides a different functionality to the users of the system so that, for example, the calendar module provides a calendaring functionality to the CRM system that is instantiated with the system. The system may also include an administration module that handles the typical administrative functions of the system. In the exemplary system shown in FIG. 1A, each module contains a subclass of a SugarBean base object 108 and each module references the SugarBean to retrieve the data from the database 110 required for display and uses certain functions and operations instantiated in the SugarBean base object.

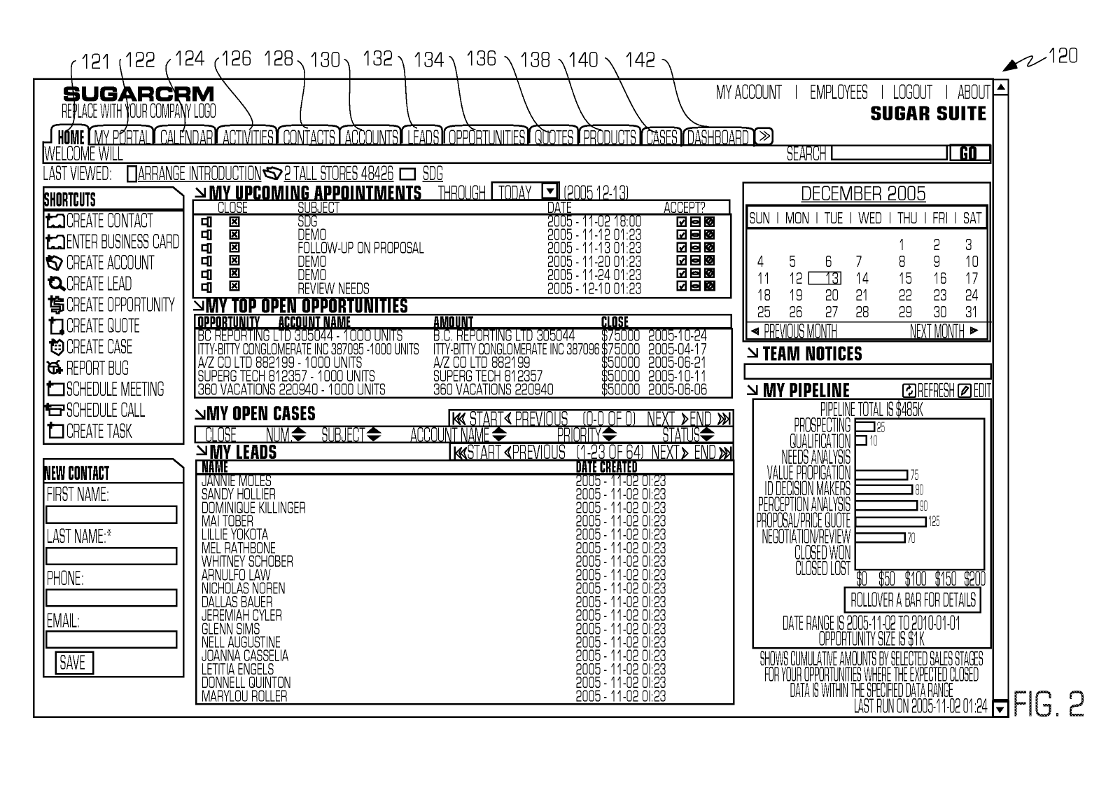

FIG. 2 is a diagram illustrating an example of the user interface 120 of the system in FIGS. 1A and 1B. The user interface may include a home tab 121 (that is selected in FIG. 2) that provides a general overview of Cases, Opportunities, Appointments, Leads, Tasks, Calendar, Team Notices, and Pipeline for the particular user since each user interface is customized for each user based on the access levels and parameters associated with that particular user. The home tab may also include shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages and to send or receive email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including website, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Enterprise are core to many business processes that require accurate data. Leads are typically fed into the Sugar Enterprise stem automatically from your website, trade show lists or other methods. However, the user can also directly enter leads into Sugar Enterprise manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account for example among other items. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with, for example, Accounts, Contacts, or Opportunities among other modules in the system and the system is not limited to a quote being associated with any particular set of modules.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard (such as that shown for example in FIG. 2B) module may be accessed using a dashboard tab 142 and permits the user to view a dashboard of the information in the CRM system.

The documents module may show the user a list of documents that the user can access, view and/or download. The user can also upload documents, assign publish and expiration dates, and specify which users can access them. The email module allows the user to write and send emails and to create Email Templates that can be used with email-based marketing campaigns. The user can also read, compose, save drafts, send and archive emails. The campaigns module helps the user implement and track marketing campaigns wherein the campaigns may be telemarketing, web banner, web tracker, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has information on hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source. The system also supports users putting graphs from their reports directly on their dashboards.

Returning to FIG. 1A, the system also includes the database 110 that contains the data of the system and a security module 112 (row level security) that implements the security methods to control access to the data in the database 110 since the database is shared by all users of the system and the data must be segregated based on the users and their access level to different pieces of data. The system may also include a database abstraction layer 114 that is coupled between the database 110 and the SugarBean object 108 and acts as an interface between the database 110 and the SugarBean object 108. The SugarBean object 108 provides the base logic required for retrieving, making available and writing information to/from the database and each module creates subclasses of SugarBean (an example of which was described above) to provide module specific details, module specific data and module specific data views. During the process of retrieving data from the database, the SugarBean 108 makes calls that populate the row level security information into the SQL engine/database management system that retrieves the data.

Once the data is retrieved from the database by the SugarBean object 108, the module uses a template mechanism 118 and a theme 116 to produce the requested presentation (user interface) for the user. The template mechanism reformats the data from the database 110 into a particular form while the theme adjusts the user interface according to the user's preferences.

If, for instance, the user requests an HTML presentation of the detail view of the contact module for a specified contact, the system may perform that request as will now be described. The request of the user is directed to controller named index.php that handles most of the logic for the main application. The controller loads the current user information, verifies authentication and session information for the particular user session, loads the language for the user (based on the user preferences) and generates some of the user interface shell. The controller then calls the contact module and request the detail view for the specified contact. The contact module then retrieves the requested contact using the Sugarbean. The SugarBean verifies row level security for the requested contact at this point (with assistance from the security module 112. If the record is not retrieved successfully, then the process aborts and the user is not allowed to view the data for the record. If the retrieve process succeeds with the requested contact data, the Contact module uses the templating mechanism, such as for example XTemplate or Smarty, in the template mechanism 118 and the code for the current user's theme (retrieved by the theme module 116) is used to create the user interface for the presentation of the particular Contact data to the particular user. The resulting user interface then is sent back to the computing device with of client that requested it.

FIG. 1B illustrates more details of the customer relationship management system 100. Like elements shown in FIGS. 1A and 1B have like reference numerals. The system may interface with a typical browser application 103 (being executed by a computing device) that can access the system 100 over the web. For example, the examples of the user interface below are web-based views generated by the system and displayed on a browser application. The system may further comprise an application programming interface (APIs) portion 105, that may preferably use the well known simple object access protocol (SOAP), to interface with other existing system and applications. For example, the APIs may be used to interface to an email plug-in 109, such as an SugarCRM Plug-In for Microsoft Outlook®, that enhances the email program to allow it to interact with the system 100. As shown, the system 100, in one implementation, is implemented on a web server application 107 (that may be the well known Apache web server that includes IIS functionality) that generates dynamic web pages (using the known PHP language). The web server and the other elements of the system may be implemented as software running on one or more servers wherein the servers may use various different operating system as shown in FIG. 1B. The system 100 may also have an email module 111 capable of sending email via a local program (that may preferably be sendmail) or an email server leveraging the SMTP protocol.

The example of the business software application system as described above may provide external form security.

External Form Security

One of the common issues when presenting online web forms for data capture to the public networks is that some people try and flood the server with bogus data. Sometimes this is an attempt to get data that they would like into the system, sometimes it is just an attempt to cause problems for others. One of the common ways to deter these sorts of attacks is to provide a portion of the online form that includes a password or phrase that tells the website being posted to that the form submission is legitimate. It is hard to make this pass phrase change often enough that it deter attacks and keep the phrase coordinated among all servers in a way that will not block legitimate usage of the forms. The security unit 112 (which may be implemented as a plurality of lines of computer code) may provide processes (which may be implemented as a plurality of lines of computer code) to provide external form security.

In one embodiment, the security unit may generate a unique password for each form that is generated and then track all of the passwords generated or the form to be tracked and appropriate submissions limits to be enforced. The process may allow more than one submission per form in case the user makes a mistake and would like to resubmit. In this process, the forms can be tracked by keeping and tracking sessions on the web server or keeping and tracking a list of the submissions mapped by passwords.

In another embodiment, the security unit may cycle through passwords on a regular basis although keeping revolving passwords in synchronization is a problem due to time drift in the servers, the delays in users taking time to respond to the forms, and other factors. The process implemented by the security unit in this embodiment provides for a time-based rotating key that is predictable. In the process, the server that is generating the form, or another server, can provide the key for placement in the form and the server receiving the form submissions can check to see if the key was generated within a reasonable time range. One example of this mechanism would be to generate a key that combines a word, the date, and the time rounded to the beginning of the hour. This data can be combined and then encoded so that it will be difficult for external people to identify how the key is generated. The server that is generating the form may use a centrally controlled time or the local time on the server. Once the server receives a response to the form, which may or may not be the same server, the receiving server may use either a centrally controlled time or its local time. There may be a configurable number of time windows which will be checked for a pattern match. If the key that is submitted with the form falls within the allowed number of time intervals, then the key will be accepted. Since the process is predictable to those who know all of the components, future, current and past keys can be calculated and the accepted time intervals can be future times, current, and past times. The support for future and past times in the process may be used to accommodate for clock skew on the servers.

There may also be some additional data or key information, the salt, that may be combined with the other data to generate the key which provides for another control that may make each set of keys unique. The salt may be a randomly generated set of bits that may be used together with the password to derive the final via processing through the derivation function. With this process, the level of the security of the forms is adjustable so that, for example, the security can initially be relatively loose and then tighten up if necessary. For example, the time interval for fresh keys can be increased or decreased and the number of intervals can be adjusted based on the complexity of the form and the frequency of successful attacks. The only pieces of information that must be coordinated are the salt, the time, and the number of time intervals accepted. The time only needs to be loosely coordinated and the system can allow for human data entry delays. This process should be complex enough to prevent simple attacks that are not retrieving the form each time they are submitting data.

Active Tracker

Referring back to FIGS. 1A and 1B, the modules 106 may include an active tracker module that provides mechanisms to record and report on user activity. This activity may include viewing, creating, editing, and deleting of records or other heterogeneous user actions that may be implemented currently in the business software application system or may be implemented in the future.

Action Mapping and Navigation History

The tracker module may have the capability to trace and record user navigation paths which may further be displayed to the user as a history of his/her navigation moves. The history may appear in a form of an activity map or a tracker bar that may display the items or tabs of the application most recently visited by the user. The user may then return to a previously viewed record by clicking on the item that represents it on the tracker bar. Alternatively, the tracker bar may provide a way to scroll through user activity as an animated list of views. The activity map may display user past actions in a visual link of chronological displays. Either the activity map or tracker bar display may provide users with dynamic features such as instant re-play, go-back, undo/restore, record, etc.

The tracker module also may provide introspection (a.k.a. “watch”) into the singular or aggregated data corresponding to actions or parameters of other users. As an example, the tracker may supply views to users with lead roles displaying current actions of the team members on that lead user's team. In a more generic scenario, the system may provide data about number of currently active users in a certain part of the application, or a number of users participating in a specific activity.

Record Auditing

An Enterprise-friendly feature of the tracker is its capability to record and audit actions performed on any individual record or sets of records within an application. The application may record all possible actions or a subset of user actions that may include but is not limited to: access, view, edit, create, delete, link, unlink, etc. The tracker system may also record actions performed on a record in an access agnostic way in which case any mode of record access would cause the tracker to log the activity, its originator, auxiliary data such as time and context, as well as any other parameters that may be supported by the application.

Application and Environmental Controls

The tracker module may extend its recording and logging functions to capture and control the system, performance and context variations. This is especially applicable for hosted and/or high availability environments. Under those requirements the tracker may log and/or control any number of environment variables, such as CPU/RAM/Disk utilization, concurrency levels, response times, query efficiencies, cache hit ratios, etc.

Application and Environmental Resource Management

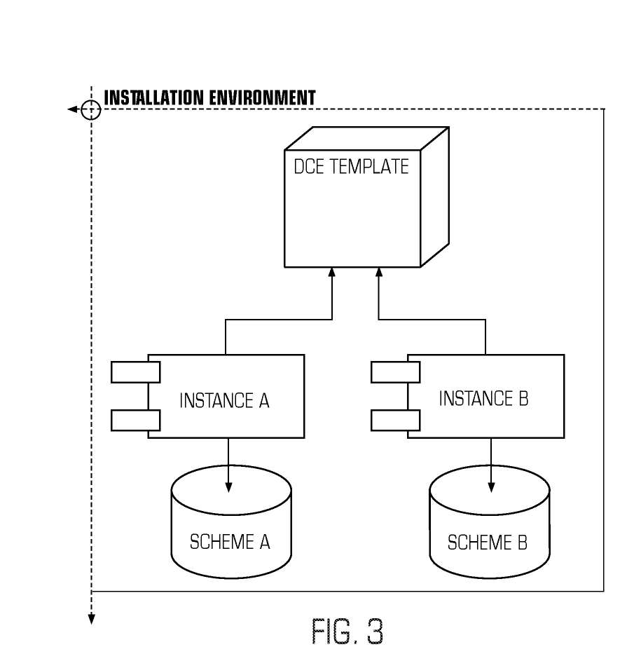

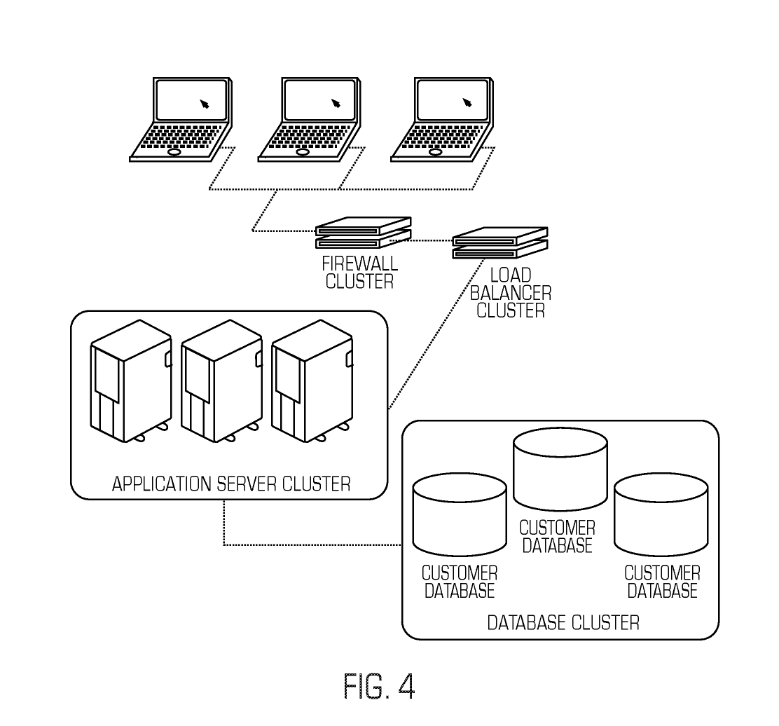

The business software application system architecture allows for a unique hybrid deployment model, which provides some advantages to some more traditional models in which the hosted application may be configured in one of the two predominant ways: 1) a single instance of the application and database may be shared among all users, including isolated groups of associated users; or 2) each group of logically associated users is served by its own individual copy of the application and database. The business software application system, such as the SugarCRM system, may be deployed in a homogenous system and application environment, yet needs to support logical data segregation for associated user groups. Thus, the SugarCRM application instance may be logically shared among multiple heterogeneous user groups while simultaneously providing distinct logical databases to each of those associated groups as shown in FIG. 3. Further details of this architecture are shown and described in co-pending U.S. patent application Ser. No. 12/100,322 filed on Apr. 9, 2008 entitled “Data Center Edition System and Method” which is incorporated herein by reference. In this configuration, the system may take advantage of shared cluster architecture, especially for the application layer as is shown in FIG. 4.

Under the constraints of a hosted, software as a service (SaaS) and/or high-availability deployment environment, it may be necessary to provide application-level controls to manage system and application resources. The application may provide resource management functionality to allow application administrator to control application functionality for the above environments and manage environment resources for the application at runtime.

This functionality is specifically different from those of virtualized components. The tracker component may provide visibility and control into the system-level functions at the higher application level, without imposing hardware or firmware-based constraints.

Awareness of Resource Limits

The system may allow the application to self-monitor its resource utilization and to react accordingly with respect to some pre-configured parameters. This serves a few purposes: the system has some rudimentary self-healing properties that allow it to recover during failure of execution either due to a faulty instruction or malicious intrusion, an external resource limit may be easily enforced in an environment that is meter-based. The following application and system resources may lie within the control of the application resource management:

Queries

The application may log and limit the number of queries made per round trip. The application may alert the user when they have encountered a max number of queries by showing some error to the user, pushing overage silently into the billing system or sending a message to a mobile device or email of the administrator. The application may stop the flow of execution when the maximum number of queries has been reached which will prevent runaway queries as in the case of poorly designed reports. The application also may allow exempt administrative users from query limits.

Files

The application may log the number of files used per round trip as well as specify location for creation of new files.

Memory

The application may monitor and limit memory usage of the application.

Application System Access Control

Most of the security attacks that do significant damage to the system (i.e. change permissions on a file, execute a script, open a back-door shell, etc.) require execution of one or more system calls. Because the system interface is well defined and the attack vector described above is fairly limited in access through this interface, we may implement a control within the SugarCRM application to construct a semantic analysis model to secure system access or to altogether disallow such an access. In the semantic analysis model an algorithm (that may be represented as plurality of computer code) may be implemented to pre-interpret all instructions requiring system-level access. This method may validate the source of the instructions is semantically mapped to a valid source location and therefore is permitted to execute as part of the instruction stack. The necessary semantic data may be provided explicitly by the source or derived implicitly from the stack of execution.

In the latter case the application may specifically prevent any system call invocation for security purposes. This is by far the simplest method to secure the system as different operating environments provide different system interfaces. This can be implemented in multiple ways. A simple way to ensure the lock-down of system functions is setup security permissions in php.ini, for example:
disable_functions=dl,exec,passthru,shell_exec,system

Application-Level Controls

The system may provide a control layer for enabling and disabling features targeted for a hosted or SaaS environment. The business software application, such as the SugarCRM application, can be deployed internally as well as in a SaaS environment and therefore provides the flexibility for feature control, specifically for features that need to be made (in)accessible in a particular deployment.

The system may provide one or more of the following features:
1. Ability to configure the Module Loader to load new package only from a repository designated by the hosting provider and not directly from local file system. The repository contains the approved packages that customer instances can load.
2. Disable the new upgrade notices. This feature is design for on-site deployments to notify of the latest updates to the system. In a hosted environment that is outside of the user's responsibilities.
3. Disable the Upgrade Wizard, since the system is administered by based on the customer request.
4. Disable the backup tool. Since backups are performed for the customer on regular basis.

Configuration and Reporting

The tracker component module may provide a cohesive user interface to allow application administrators to configure and edit control parameters that affect tracker functionality and performance. Since tracker may provide high detail of output it may effect application performance and thus need to provide an easy way to tune parameters as to balance customer requirements and the performance of the system.

The tracker also may report on a configurable continuum (min, hours, days, months, etc.) by aggregating corresponding data based on a pre-defined configuration. The tracker also may provide some build-in impact estimation and self-tuning capabilities based on the frequency and volume of writes required by a particular operational setting. The user interface may display this estimation visually as the settings are being changed by the administrator on a scale from “no impact” to “high”.

The tracker may also provide a reporting utility that may allow the user to query system for aggregated information on the data accumulated by the Tracker component. This data may be graphed to provide a visual representation of the state of the system, including color-coding of high-risk results.

Tracker Log Authority and Storage

The tracker module may provide record auditing, integrity and safekeeping. Since this component is intended, among other things, to ensure consistency and compliancy, the tracker provides a secure and unalterable way to store and access its data. This feature may be obtained by providing a fully encrypted and separate data store for the tracker component. The tracker may also require a separate set of authentication keys to gain access to its data store. The tracker also may provide a configurable data retention policy settings to specify where, how and in what form to back-up and retain its data.

Resource Management

The SQL query management features may be divided into two parts—configuration and execution. The execution features deal with the runtime operation of registering for notification if a query count threshold limit has been reached, setting a default or special threshold limit, and handling any error(s) that may occur when the threshold limit has been reached.

Administrators may configure settings in the config.php file to set a default query limit or add modules to an Array which gives a special query limit. Should this limit be reached by the request (be it from SOAP or the browser), execution will halt and errors will be sent back.

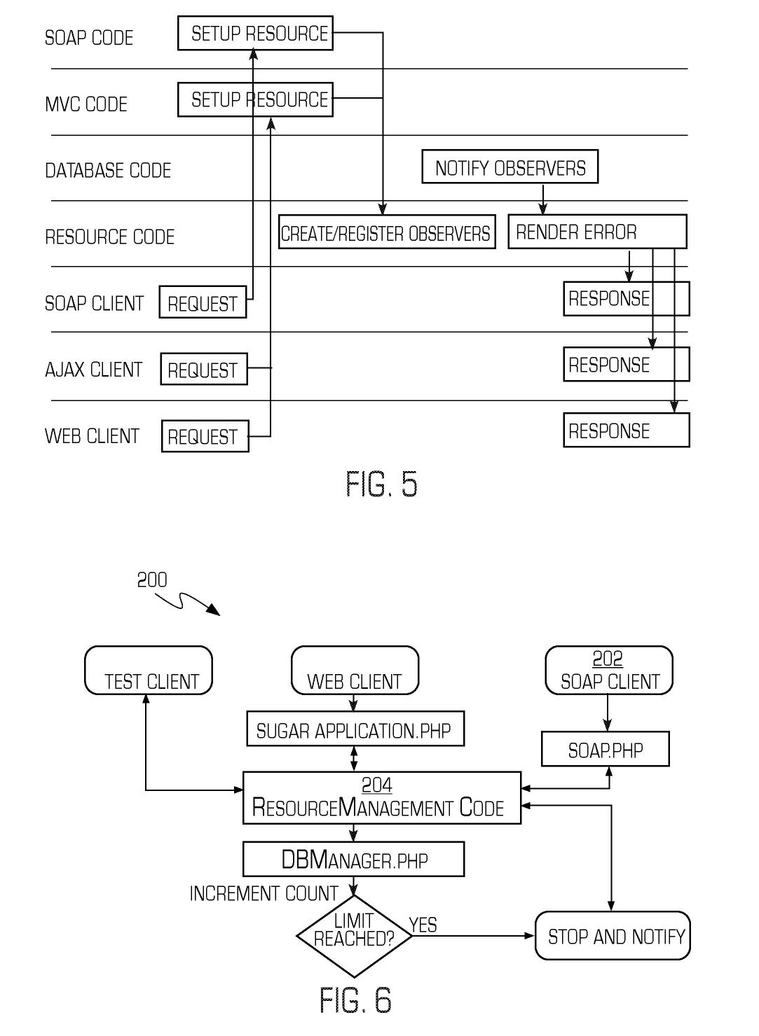

FIG. 5 illustrates a workflow of a resource management method in the runtime. As shown in FIG. 5, the actors in the resource management include Simple Object Access Protocol (SOAP) code, model-view-controller (MVC) code, database code, resource code, a SOAP client, an Asynchronous JavaScript and XML (Ajax) client and a web client. As shown, the SOAP, Ajax and/or web clients may make a resource request wherein SOAP code and/or MVC code is used to set-up the requested resource and then creates/registers observers in the resource code. The database code may then notify the observers, possibly generate an error and provide a response to the client(s) that originally requested the resource.

FIG. 6 illustrates a flowchart of the resource management method 200. In the method, one or more different clients 202, such as a test client, a web client and a SOAP client, may access resource management code 204 using separate entry points since there are multiple clients for the code. The most common entry point will be via the Web Client and this refers to requests executed from web browsers. Since web requests go through the root level index.php file which calls SugarApplication.php, SugarApplication.php is where the web requests will interface with the resource management code. In the SugarApplication.php file, the resource management code may be added after the entry point code has run to setup the request based on the configurations. The SOAP clients, on the other hand, may access the resource management code through soap.php. The resource management code may interface with the database manager code (DBManager.php) which will determine if the particular resource limit has been reached and notify the resource management code if the limit has been reached.

In general any system resource can be considered to be a constrained resource. An embodiment of such a system may include CPU, RAM, DB Connection, Socket, and other resource management and throttling. In the design example above the number of open database connection may be restricted on a system that is shared among multiple application instances. The resource constraints may be different for each instance, for example instance A may be allowed a maximum of 25 open database connections, while instance B may be allowed 50, etc. In this example the main offenders might be malicious or erroneous code executions within the application that may exceed the normal usage scenario.

Data Collection

A process of data collection happens automatically during normal operation; therefore the first Actor is the System. The system may generate reports making use of the collected information that may be viewed by the Admin, Managers, and Users (known collectively as the SugarCRM user). The tracker module can capture information about user sessions, actions, SQL metrics and performance metrics.

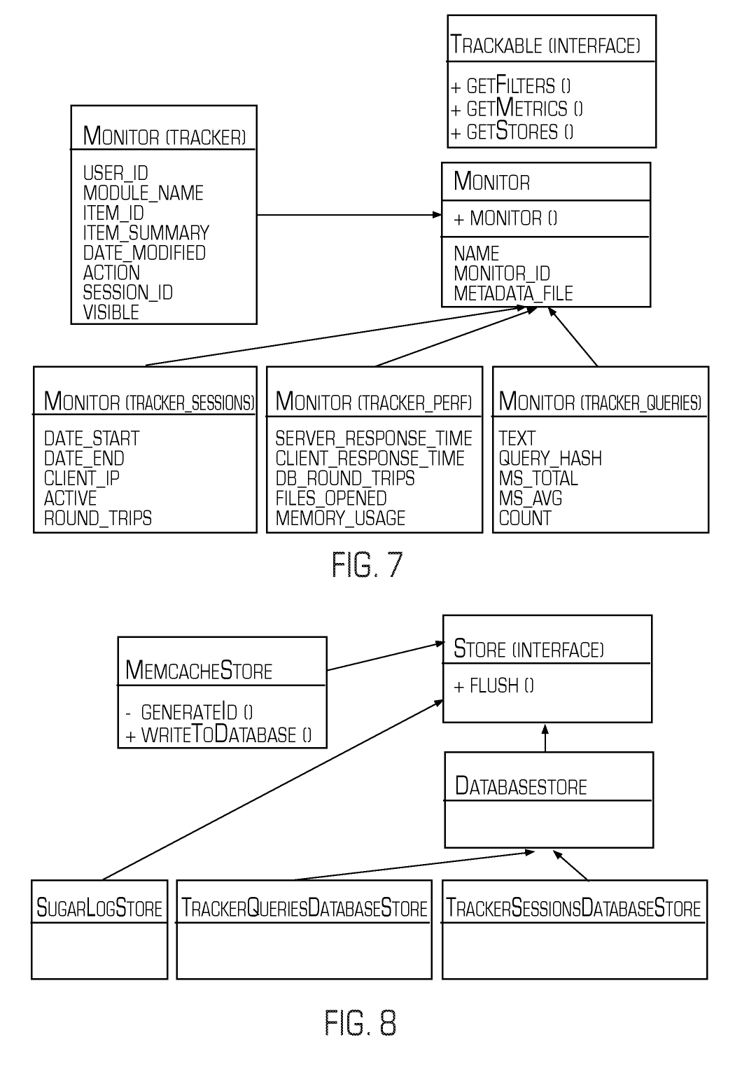

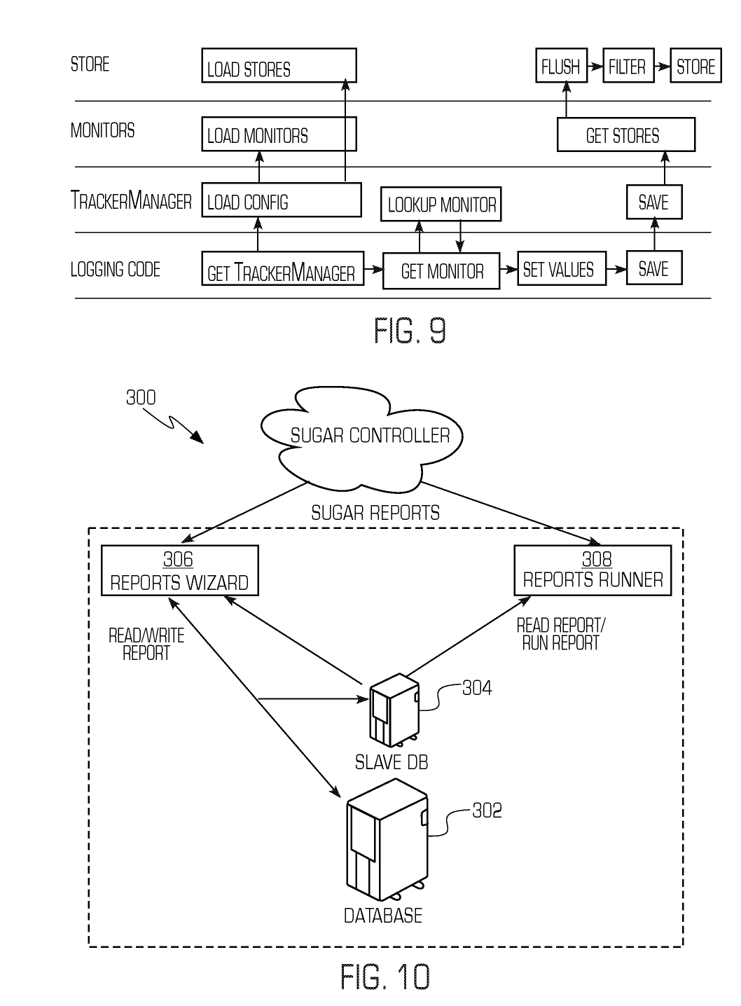

In one implementation, there may be five database tables that store the information and they are defined as follows (as shown in FIGS. 7-9):

| Table Name | Description |
|---|---|
| TRACKER | The basic tracking information (user id, module |
| | name, action, item id and item summary) |
| TRACKER_PERF | The performance related information (database |
| | access, file access, server response time and |
| | memory usage) |
| TRACKER_SESSIONS | The session data for users accessing the system |
| | (session round trips, date start, date end) |
| TRACKER_QUERIES | Slow queries that exceed the slow query time |
| | limit are tracked in this table |
| TRACKER_TRACKER_QUERIES | This table records the many-to-many |
| | relationships between the tracker table and the |
| | tracker_queries table (a request could |
| | potentially result in several slow queries being |
| | tracked) |

Individual views the history of his actions in the breadcrumb bar.

A SugarCRM user views history of all users and various reports via the Reports module or the tracker dashlet. The reports in the Reports module may contain charts and display summary metrics whereas the reports in the tracker dashlet executes SQL that is otherwise not possible via the Reports module and displays the data in a grid format.

An Admin may configure, via a configuration file, what type of storage mechanism to use (database, file, none, etc.). For one implementation, DatabaseStore (database) and SugarLogStore (sugarcrm.log) may be supported, although the tracker may use to the other storage mechanisms as shown in FIG. 8.

The team security rules (described in more detail in U.S. patent application Ser. No. 11/255,674 filed on Oct. 20, 2005 and entitled “Team Based Row Level Security System and Method” which is incorporated herein by reference) are applied to non-admin users for tracker reports. The non-admin user's private team id will be used as the team value of the records they can view. This means that reports showing team information may be a subset of what the admin users may see. If the chronology (cron) scheduler is setup, the tracker tables may remove all entries from the five tracker tables that are older than 90 days based on the date_modified value except for tracker_sessions table (which uses date_end value). Also, the tracker_sessions table will be updated and the active flag set to 0 (or false) for entries whose date_end value exceed 20 minutes.

Dynamic Visual Application Designers: Module Builder & Studio

The business software application system as shown in FIGS. 1A and 1B may include one or more components (implemented in one embodiment as a plurality of lines of computer code) that assist the users of the system. For example, the business software application system may include a module builder component and a studio component wherein these components provide users with the ability to create new application layouts, fields, features, pages and sub-applications. Both components may be extended to provide further capability to create inter-relationships among new components they create.

Additionally, the components created herein may have configurable relationships to the previously existing components in the CRM application and therefore the persistent data of both generated and native components may be accessible in a homogenous fashion.

The Relationships Editor

A Relationships Editor may allow a Sugar Administrator to view, create, modify and delete entity relationships present in various modules either via Studio or Module Builder.
Viewing existing relationships—the admin may be able to choose any module and see a list of existing relationships between that module and other modules, complete with basic information such as cardinality. If the relationship is editable, then clicking on it will open a view to allow the admin to edit it. Relationship constraints may be enforced/established at the time of modification.
Editing/deleting an existing relationship—relationships created through the Editor will be editable. OOB relationships will not be editable because the OOB relationships are required for the correct operation of the OOB modules. Other relationship constraints may be enforced/established at the time of modification.
Creating a new relationship—the admin will be able to select a module, and use the Editor to create a new relationship between that module and any other permitted module. The Editor will create all needed sub-panels, fields, and metadata relationships. New relationship constraints may be established at the point of relationship creation.

The system presumes that all relationships are created ‘complete’: that is with all the required fields, sub-panel definitions and relationship definitions to be added at the setup time. The Editor may support in-flight definitions to provide for better usability during the setup process. In this case a field may be added to the module at the time the relationship definition is being created.

Types of Relationships

The system may support three types of relationships: one-to-one, one-to-many and many-to-many. A one-to-one relationship is created as two related fields, one for each side of the relationship; a one-to-many relationships are made up of a relate field and a sub-panel; a many-to-many relationships is created as a link between two sub-panels. Multiple relationships, including self-referential relationships, may be created between any two modules.

One-to-many and many-to-many relationships may contain additional conditions, known as relationship_role_column and relationship_role_column_value, where the only rows to be included will have the value relationship_role_column_value in the column relationship_role_column.

When in Studio, relationships may be created between any two deployed modules; i.e. modules which are installed and usable. In Module Builder, relationships can be created between any known modules, either already deployed or currently in development. Relationships are first defined and then deployed, or made active. In Module Builder, a relationship may be deployed along with the rest of the module as part of an installable package and relationships can be deleted in Module Builder by selecting the relationship and then clicking the delete button. In Studio, a relationship is deployed by choosing the deploy button from the editor, and once deployed (that is, in use), no changes are possible from Studio.

History and Resolution Management in Dynamic Visual Designers

The system may record all changes that have been placed in a Studio component. The User Interface may provide the application administrator with the ability to review older versions of the application component along-side with the current or other version. It may also highlight the differences in order to allow the administrator to compare the versions side-by-side and to perform merges on any specific fields within those views.

Excel Plug-In

An Excel Plug-in (similar to the email plug-in 109 as shown in FIG. 1B and implemented in a similar manner) may be a tool that users can use to create, delete, and modify records in the business software application, such as SugarCRM. This may provide the availability of a familiar reach User Interface with the convenience of on-line collaboration and synchronization with the central CRM application in the CRM embodiment.

The Excel Plug-in also enables users to quickly update existing records in the business software application, such as SugarCRM, without needing to map a specific field. Instead of undoing the import all together, they can simply populate the fields that are already created.

This plug-in enables users to perform basic CRUD commands (create, read, update and delete). This plug-in also can create ad-hoc reports allowing the user to join tables if needed, along with pulling in results from existing reports in Sugar. The Excel Plug-in may look similar to the Word Plug-in where there is a toolbar added to Excel that offers the user different options and the options may include (but are not limited to):
Login
Settings
Query Wizard
Update Records
Insert Records
Delete Records
Logout

The features of the Excel Plug-in may include:
Query Wizard
Update Records functionality
Insert Records functionality
Delete Records functionality

Data Editing, Synchronization, Communication Alerts

The data modified by the Excel Plug-in may be available in near-real-time to other online CRM users. This may enable more efficient and timely business processes to take place. The Excel Plug-in may also provide synchronization mechanism for resolving multiple edits. This may be important in cases where multiple users are collaborating on the same dataset.

The Plug-in design may provide for an Alert mechanism to allow a user to specify that other users of the dataset should be alerted on any changes committed. In this case a notification or a color tag may appear to other users to display any changes made by the editing user.

Reporting: Query Wizard.

The Excel Plug-in component may provide reporting functions to enable the user to query and analyze their excel data. This feature allows the user to build queries directly from Excel. The Plug-in User Interface may provide a dialog box, which may appear and walk the user through the query creation process, giving the user the option to create an ad-hoc query or to retrieve the results from an existing saved report.

If choosing to view the results of an existing report, the user may be taken to the next dialog window displaying a list of all the saved reports that they have privileges to view. They can then highlight the report in the list and click a GO or RUN button.

If choosing to create an ad-hoc query, they are taken to the next dialog window prompting them to choose the tables and fields in which they wish to run the query against. This feature also provides the ability to join related tables. The filtering options include filtering on binary and logical operators, including but not limited to:
Is
Equal
Contains
Starts with
Ends with
Does not equal
Is empty
Is not empty

The filtering page also provides the ability to use the AND/OR functionality.

ER-Based Visual Reports Builder

The system may embody a visual component for simplifying query language by representing entity relationships visually and allowing the end user to drag and drop entities of interest into the results pane. The necessary fields may be visually related to identify persistent or dynamic relationships between entities.

Importing Data

Importing data into a business software application, such as a CRM application in the illustrative embodiment, is a very frequent requirement. For example, new data needs to be added to the system and old data needs to be updated based on external sources. When importing data into the business software application, such as a CRM application in the illustrative embodiment, the data may be parsed in a more efficient way than a simple replacement of data.

A common importing framework may be used. This framework may read the data efficiently. It may leverage common objects that are reused to decrease the memory footprint of the import. The system may handle build in module and also modules created by third parties.

The importation method may be broken down into stages. Each stage may represent a step in the import process that maps to a business function in the process workflow. Each stage can be efficiently performed and then pass the data on to the next stage. This allows the server to pool common data needed to each stage only when it is working on that stage without having to store all data for all stages at the same time.

In further detail, imports may be broken up into waves of entrees, where each wave processes a portion of the data. For example in a large batch import, where tens or hundreds of thousands of records are submitted, those records may be broken up into smaller batches, or waves. Having the import broken down into waves will decrease the amount of memory used at any given time, since the amount of memory used is usually proportional to the number of objects processed. Breaking the import down into waves may also provide another change to provided feedback to the user of the application. The waves should provide a reasonable chuck of processing where it will make sense to let the user know that progress has been made. Updating the user too frequently may require too much processing or network overhead. Breaking larger import files into waves may allow the system to process much larger files than can be stored in memory at any given time. The system will have to remember the file that is being imported and the current location that the system is on in the import. These simple pieces of information will allow a single import process to step through an entire file. The system may also have the ability to store locking information for the file to be imported. When an import process is about to work on a file, it first locks the file. If the import process can obtain the lock, it stats working on the file. If it cannot obtain the lock, it tries another import job or waits until later. This locking mechanism will allow multiple importers to work on the same file without conflict or importing duplicate entries.

Breaking imports into waves may also allow implementation of sharding the import data across multiple processing units. This would allow foe heavy parallelization of the import process during any single processing stage. If the data shards are split amongst a cluster of servers certain meta-data may be required to be passed along with each shard to ensure that the output of the processing is aligned in a consistent and correct manner.

Finally, not all types of imports may allow for either waves or shards breakdown. Those imports may rely heavily on the contextual flow of data. In that case the import may be flagged as contiguous and no break-up would be performed by the application on those data imports.

In addition to importing files while the user is waiting, it should be possible to schedule imports. The user may be able to schedule a job based on a file that they upload at the time of scheduling, based on a file that can be retrieved from a specified location, or based on a file that will be provided later. It may be possible to have the import process create a destination file that the user or another server can upload later. It may be possible to have the system automatically look in specified locations and import any files placed there. When a file is transferred completely to that location, it may automatically be scheduled for import.

The system may support common data file formats such as comma-delimited values and tab-delimited values. The system may support common encoding formats and simple encoding including: ‘Double Quote’, ‘Single Quote’, ‘None’, and ‘Other’ which allows for a character to be provided for quoting. The system may also support custom delimiters and quoting. The system may also support having a plug-in architecture that will allow a piece of software or third party system determine how to translate the import data into the data that the business software application needs. This mechanism can be something as simple as decoding a complicated or arbitrary encoding format or as complicated as taking a list of IDs and then retrieving all of the data from an external systems at runtime. Any algorithm can be provided by to the import process along with the data. Additional calculations can be defined during the import mapping process or by the algorithm provided for translating the data. In addition to parsing the data out of import jobs, the system may also support a field mapping or header row in the data. This mapping allows for the fields to possibly be reordered in the data source and still have the mapping remain valid. Header rows are also a great way to assist the user in creating an accurate mapping. If a header row name matches an existing field name or database name in the system the system may default a new mapping to match up those fields.

The system may provide a user interface for defining import jobs. This system may allow for the mapping of fields from the import data to fields and objects in the software system. The system may also allow for supporting calculations based on the data for the row. For instance, if someone would like to translate one numbering system to another during import, this can be easily accommodated. Also, if one field is based on some manipulation of a couple of other fields, this can be performed. A few examples of this kind of calculation would be adjusting case consistency (upper and lower case), rounding to appropriate levels, combining dates and times if provided separately, adding time zones if not provided with a date and time, manipulating data from one format into another based on the difference between the format provided and the format needed by the system. Another example of data manipulation is to transform provided data into a consistent format with what is stored in the database. If the record being imported is in the United States of America, then the many different symbols for each state can be mapped into one consistent state symbol such as the US Postal two letter IDs for the state. Additional parameters about the import file may be supported. Some example parameters may include:
File Encoding
Date/time formats
Time-zone
Currency Symbol
Currency Significant Digits
Decimal symbol
Name Display Format

The system may also allow for the specification of values for columns that are not provided by the data source but are desired by the software system. If you are importing leads generated by a campaign for instance, you might want to add the campaign in during the mapping phase and not have to add the campaign information to every row.

The system may also allow for naming and storing the mappings generated by the user for later reuse. It is common for defined import jobs to be executed many times. Some parameters in the mapping may be requested when the job is being scheduled or executed. These parameters may be provided interactively by the user, in a separate file, or from an external source. An example of this kind of parameter is the campaign to which newly imported leads should be associated. The lead format may be consistent, the import mapping is the same, but the campaign to be associated with the leads to may be import specific. The system may also have common variables that can be specified. The current user and the current user's default team are two examples of common variables. If a user is importing some leads that they would like to have owned and assigned to themselves, they may be able to use a shared mapping that defaults the team and user to the current user's default team and the current user respectively. This simple addition to the system allows for common import mappings to be defined and used by many users instead of requiring one mapping per user or requiring the user to remember to update the mapping before running the import.

Multiple import mappings, decoding, and association algorithms may be defined. Some of them might be based on the tool in the system, others might be provided by the user. This will allow for multiple transformations to be performed on the data being imported, detailed data manipulation, and reuse of transformation and cleansing algorithms. If you have one algorithm for decrypting the data, another for pulling the block of data apart into different fields, another for decoding each field, each of these algorithms can be applied successively and can be reused later as part of a different flow. If one import data source is not encrypted for instance, you can remove the decryption from the flow without having to rewrite all of the other steps.

The system may have the ability to look, after transformation, to see if there is already a duplicate record in the system. When defining an import job, the duplicate resolution process is decided on. Among other actions, the system may support, replacing the existing record, importing changed fields, not importing the record, or flagging the record for later processing. The duplicate fields may be based on standard duplicate definitions already in the product or with specified fields or combinations of fields.

The system may also support quality-checking algorithms applied at the time of import. The checks may be based on the type of data being imported or provided as a plug-in. An example of an email address data type may check:
Only legal characters are included
There are a minimum number of characters and the ‘@’ symbol is included
The domain name of the email address is valid
The domain name is already known
There is a mail server responding at the domain name (which may make it a known domain name).

Reports

The business software application system may have an engine in place for configuring, displaying, and exporting reports that may be part of the modules 106 as shown in FIGS. 1A and 1B. The report unit may be implemented as a plurality of lines of computer code in one embodiment. The system may allow use of the output of reports to generate mail merges and the mail merges can be heavily segmented based on the filters and grouping options defined for the reports.

FIG. 10 illustrate an example of a reports unit architecture 300. The unit may have a store 302 (that may be the database 110 shown in FIG. 1A or a separate database or other data storage device/software) and a slave store 304 wherein the slave store may be optional and, in the absence of the slave store, the transactions are handled by the store 302. The reports unit 300 may further comprise a reports wizard 306 and a reports runner unit 308 wherein the reports wizard allows a user to read/write a report (described below in more detail) from the store 302 or the slave store 304 and the reports runner allow the user to read or run a report from the store 302 or the slave store 304.

The system may also provide for the ability to merge records contained in a report. This will allow a user to see two or more records that should be the same record and combine them into a single larger record. Users that have a higher level of visibility can then run reports that included data that spans that which other users have access to and perform cleanup operations such as merging duplicate or similar records.

The system may allow reports to be exported into data for external programs in different formats with different quoting options including but not limited to all of the options described in the section on supported import formats (see the common data file support described above in the “Importing Data” section). In addition, the formatting options described above may also apply to allow the systems data to be converted into a format acceptable to the external program. The external program might also be able to call to the system and request the data from a report on request or on regular intervals. One such supported program might be Microsoft Excel. There may be a menu item added to Microsoft Excel that would allow the user to import data from the system directly into their worksheet.

The system may also have the ability to print the report to the well known PDF format. The PDF document should contain the data and the graph. If possible, the data should optionally support links back the system for further work. The system may also permit a user to add charts and table as dashlets and/or add charts and tables in a Wiki page.

Reports Functionality

The report may support multiple relationships and thus allow navigation of more than one relational objects. The reports also may support multiple group-by's with more than one group by's and charts to reflect the stacked bar charts created. The reports may also provide support for outer joins and support outer joins by the query engine. The reports may provide reporting on audit tables so that the reporting engine is able to create historical reports on audit data. The reports may also provide various basic operations including:
Create
Edit
Delete
Search
Create views
Team access controls
Tracker views

Report Types

The user of the business software application may choose, for example, from three report types including tabular reports, summation reports and matrix reports. The tabular reports have a normal table view of the data with no capability to sum or average and allow export, print and mail merge features. The summation reports (described below in more detail) may provide reports with sub totals and summations, multiple group by's that enable sub totals at group level, sum and averages for numeric values and limits to three group by's. The matrix report may summarizes data in a grid format against both horizontal and vertical criteria, cell values should accept sums or averages, the total value can accept sums or averages and may be limited to three group by's. The summation report may include summation criteria that may include: sum, average, smallest value or largest value.

These operations should be applied to all the numeric values in the record and the related record.

The system should allow the creation of calculated fields at this stage: information that includes price and quantity, the user can create a new field (call it TotalOrder for example) by multiplying price and quantity together. The system also may provide support for expression (a formula that is a function of other cells and values). A summary request can be as simple as summing one field by another or as sophisticated as having a unique set of records aggregated for each cell of a report.

The reports may include groupings. The groupings are only applicable for summation and matrix reports and should allow to create three group by criteria's. The format engine should allow to display the groups in the UI with sub totals and averages and the charts should reflect the multiple group bys. The system should allow to define sort orders at each grouping levels, allow grouping of dates by days, weeks or months and allow grouping by quarter and year.

In the columns user interface for the reports, the user interface should allow users to pick the data that shows up on the reports and should honor the team security model. The user interface should honor the access control lists (ACL's) and field level security. For table reports, the user can define the order by columns. In the reports, the description and long text field should only display the first 255 characters. The user interface to select and deselect all should be provided and provide tools to define the order of the fields. The user interface also allows the fields from all the related modules should be displayed as well.

The reports also may include filters that support AND and OR filters and also permit any combinations of ANDs and ORs in a filter. The filters user interface allows groupings of multiple ANDs and ORs and allows the user to add or delete filters. The filters user interface may also provide a text mode to create groupings. Once a report is created and saved, user have the option of changing the filters at run time although this does not change the actual criteria. The user interface also may allow the user to selectively clear filters in a report at any time.

For example, a user creates a report on Opportunity filtered by Sales stage=XYZ and grouped by user name and then runs the report. The user then wants to see the report with a different filter, such as ABC, and changes the filter using a filter change user interface and the report is rendered with the results with the new filter. However, the new filter is not applied to the actual report so that, the next time the user runs the report, the original filter is used. However, the user may choose to save the new filter in the same report or save as a new report.

Charts

The reports module is able to generate charts including summation and matrix reports. The reports module may support line charts, horizontal bar charts, vertical bar charts, pie charts, gauge charts, funnel charts and grouped bar charts (for multiple groups.) The reports module allows a user to clearly specify the axes and data points that should be shown on the charts. The user interface may allow the user to define a chart description and label and a data series for the graph.

The summation graphs may include summation graphs for a single group, summation graphs for two group bys and summation graphs for three group bys. The user interface for summation graphs for single groups may list the numerical summation options that may include counts, averages and sums. The user interface for summation graphs for two group bys may list the numerical summation options that may include counts, averages and sums, but for a pie chart, the first summation values will be taken. The user interface for summation graphs for three group bys may list the numerical summation options that may include counts, averages and sums, and the user should be given an option to anchor the graph from the first or the second summation anchor.

The matrix reports may include a two group matrix report and three group matrix report. The two group matrix allows the user the option to pick the axes. For a three group matrix, the chart should be grouped by the last two grouping anchors but the chart should have an option select the first anchor at runtime.

The funnel charts are used to show the convergence of data from the entry level to exit level. It is typically used show the sales pipeline at any point of time. Funnel charts are often used to represent stages in a sales process. For example, the amount of potential revenue shown for each stage. This type of chart can also be useful in identifying potential problem areas in an organization's sales processes. A Funnel chart is similar to a Stacked Bar chart in that it represents 100% of the summary values for the groups included in the chart. The funnel charts are usually good for one or two grouped reports. For a single anchor point, this graph represents the allocation for various data sets. For example, an Opportunities by sales stage is a classic funnel chart, the chart is usually computed as a % and the sales stages are ordered by the actual stages in the sales process. For a multi anchor point report, the chart may have a drop down to filter by the first anchor point. For example, an Opportunity by user by sales stage and the chart will have a filter for user.

The gauge charts presents values graphically as points on a gauge. Gauge charts, like pie charts, are typically used for one group of data (for example, the percentage of sales for the entire inventory).

All types of charts may provide dynamic display functionality by allowing to zoom into the represented data and navigate visually through the information represented in the chats.

Exporting

The charts generated from the reports may be easily added to the dashboards (described above) and to the homepage as a dashlet. The tables generated from the reports may be added to the dashboards (described above) and to the homepage as a dashlet. The tables and charts created by the reports module may be embeddable in Wiki and blog pages which will allow the creation of Wiki and blog documents with mixed content types.

Auditing

Apart from cross module reports, the system can provide tools to report on the history of a particular record such as the time and status of an opportunity in its life cycle or the summation of all of the time that opportunities spend in all of its statuses.

Packaging

The dashboard reports may be packaged as cases by priority (how many open cases does a person have by priority), customers by industry (how do the customers break down by industry), forecasts by rep (how much each sales representative is projected to bring in during a time period), Leads by lead source, Open opportunities, Pipeline by competitor or Pipeline by region.

The account and contact reports may be packaged as active accounts (what are the current active accounts for a user), neglected accounts (which accounts need attention), account owners (who owns what account), contact role report (who are the contacts involved in a user's current deals), new accounts (what accounts have been recently added), and partner accounts (which accounts are partners).

The opportunity and forecast reports may be packaged as Opportunity by stage, Opportunity by Products, Opportunity by type, Opportunity by source, Closed and Open opportunities, Opportunity history reports (that show the lifecycle of the opportunities of a user), opportunity stage duration report (that show how long an opportunity spent at each stage), forecast reports (that show the forecast amounts, best case forecasts and pipeline by period) and forecast history report (that show the lifecycle of forecasts for a particular user.)

The sales reports may be packaged as quota vs. actuals, sales by account, sales by partner, sales by rep or sales by lead source. The lead reports may be packaged as lead lifetime (that tracks the life of a lead from creation to closure) or a leads by source. The support reports may be packaged as total cases created or total cases per agent.

The campaign reports may be packaged as campaign ROI analysis report, a campaign revenue reports or a target list reports. For example, the system may generate a target list of all client Presidents located in Ohio, generate a target list of all client Quality Managers for accounts whose ISO 9001:2000 (custom account field) certifications expire (custom account field) within the next 12 months, generate a target list of all contacts whose title includes the word “Manufacturing”, generate a target list of all contacts with a salutation of “Dr.” whose company is in the Medical industry or is a Hospital or generate a target list of all contacts over the age of 50 (custom contact field) who work in the Entertainment industry.

The activity reports may be packaged as tasks and Appointments (what are the open/completed activities), campaign and reports, forecasts and reports, activities and Reports or self service reports.

Export to Excel

The system may provide tools to export to excel. For example, the system may have a tool to create standardized list views that enables the following features: Search and advanced search; Saved views; Mass updates; support for classifying favorite reports and support for following actions: Edit, Delete, Publish and Schedule. The system may also provide a dashlet to expose favorite and other reports per user defined criteria, a tool to arrange reports in folders so that the user can create folders for organizing reports, folders can be exposed as a tree in the user interface, the folder structure may be at least two levels deep, users can share a folder with teams and other users and the following actions should be supported: Create, Edit, Delete, Modify and/or Share.

The system may also include a report generation process that may be wizard driven with the following processes:
Define reports
   Will have the general options including selecting main dependent modules
   Team and user information
   Name and Desc
Define report type
   Rows and Cols
   Summation
   Matrix
Define summation criteria
   Sum
   Average
   Smallest value
   Largest value
Define groupings
   Create multiple grouping
   At least three required
Choose display columns
   Must honor ACL and field level security
Define Filters
   AND and OR
Define Charts
   Only for summation & matrix reports

The report generation is usually a power user feature but SMB's generally have users that are not well versed with reporting or data marting. The wizard steps should be associated with detail explanations and implications of the options that users pick in the process. For example Details should be provided when a user picks the report types summation vs. matrix etc. This will improve adoption and fewer calls to support.

Wireless

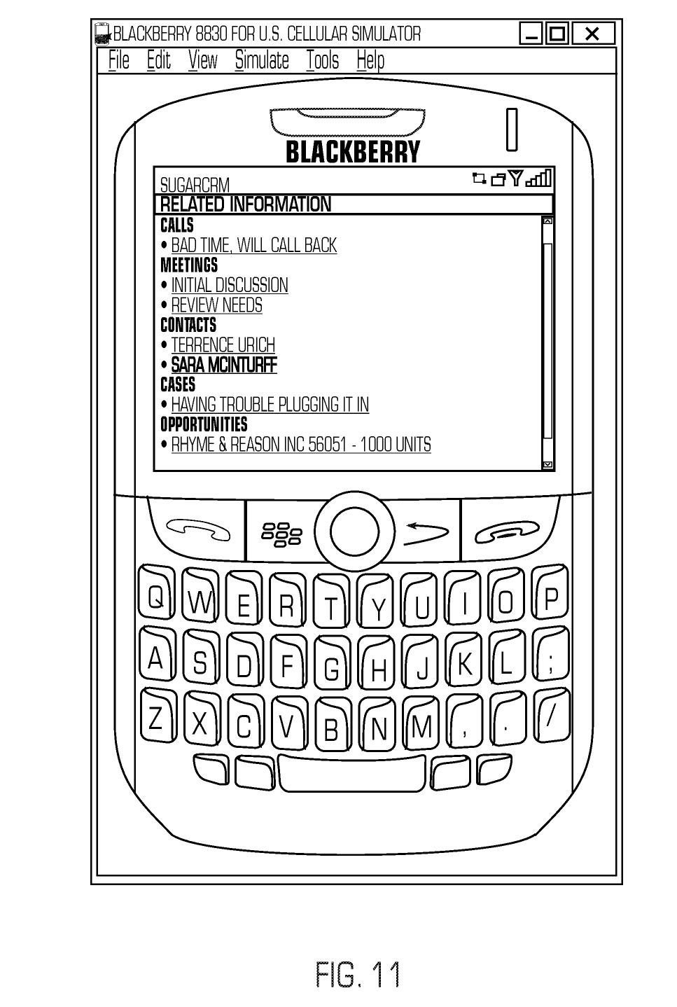

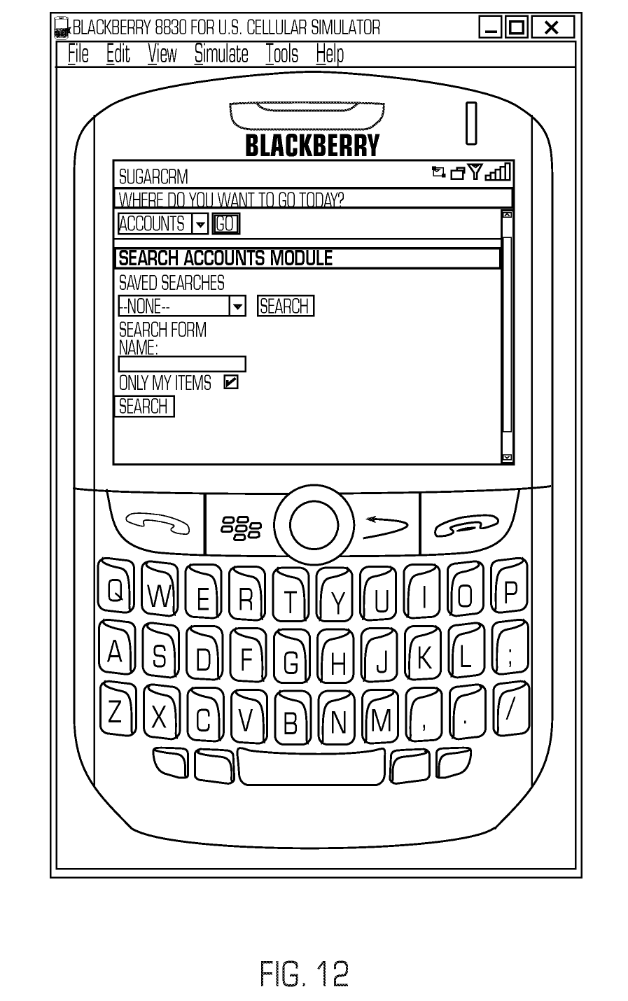

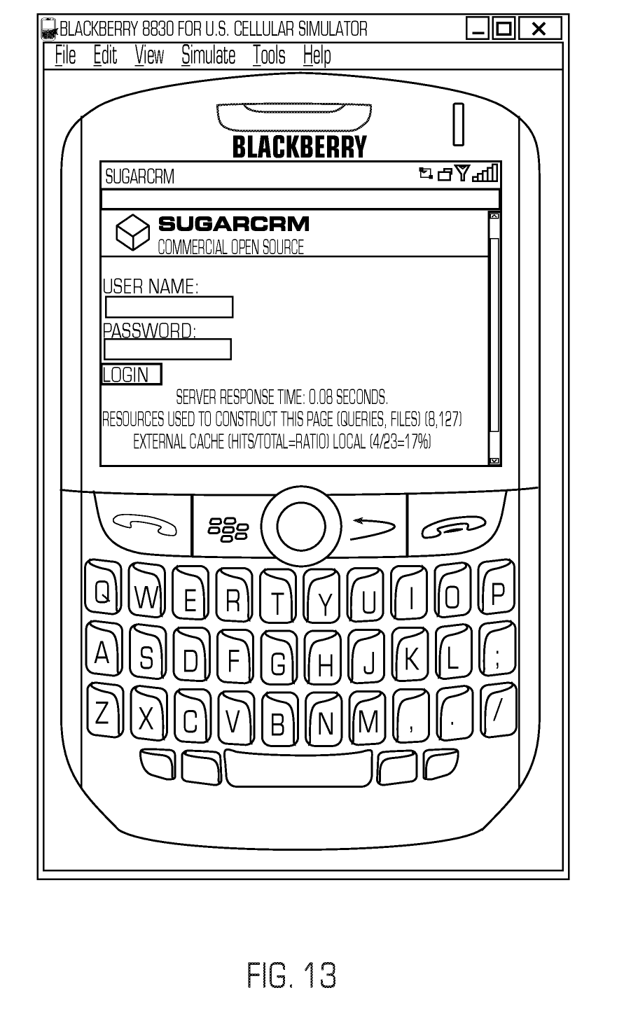

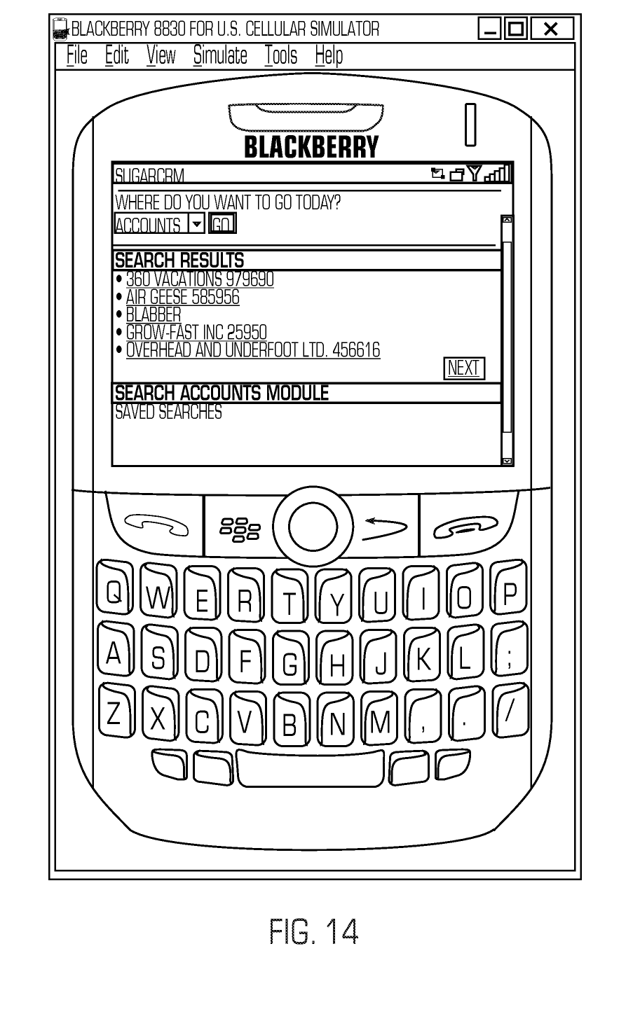

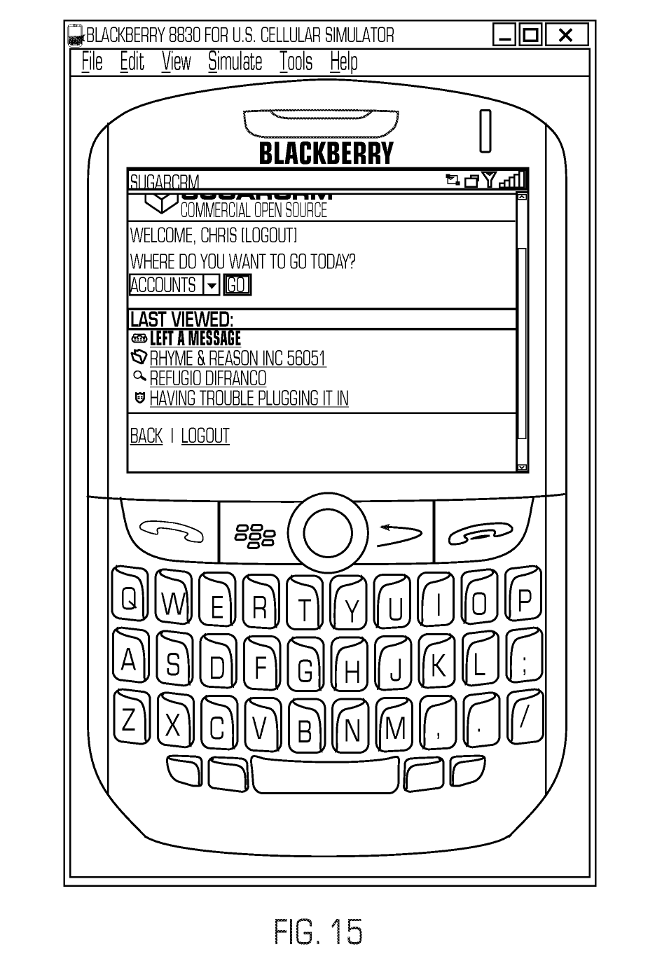

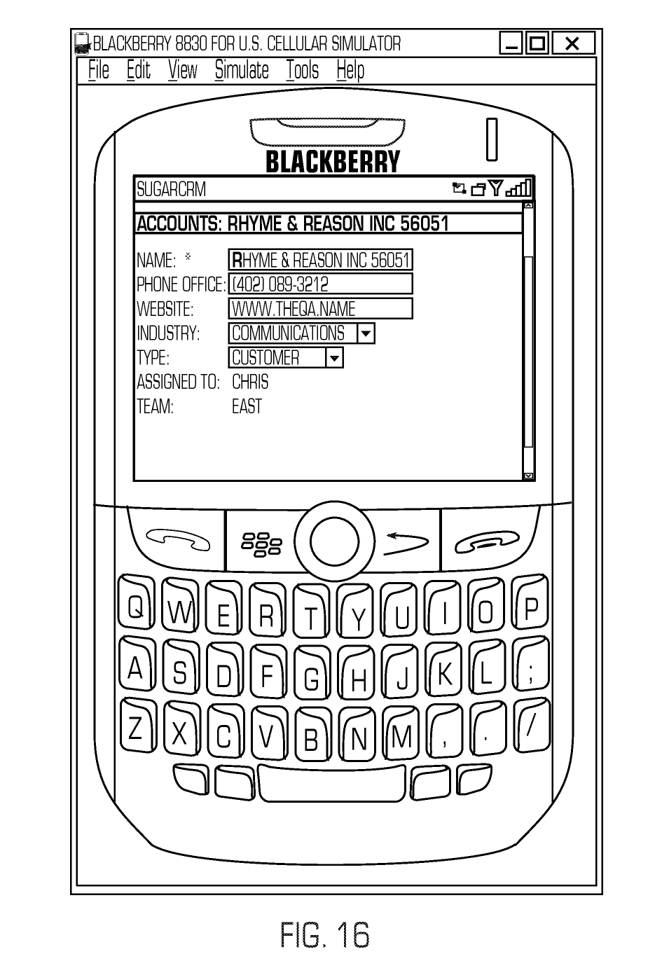

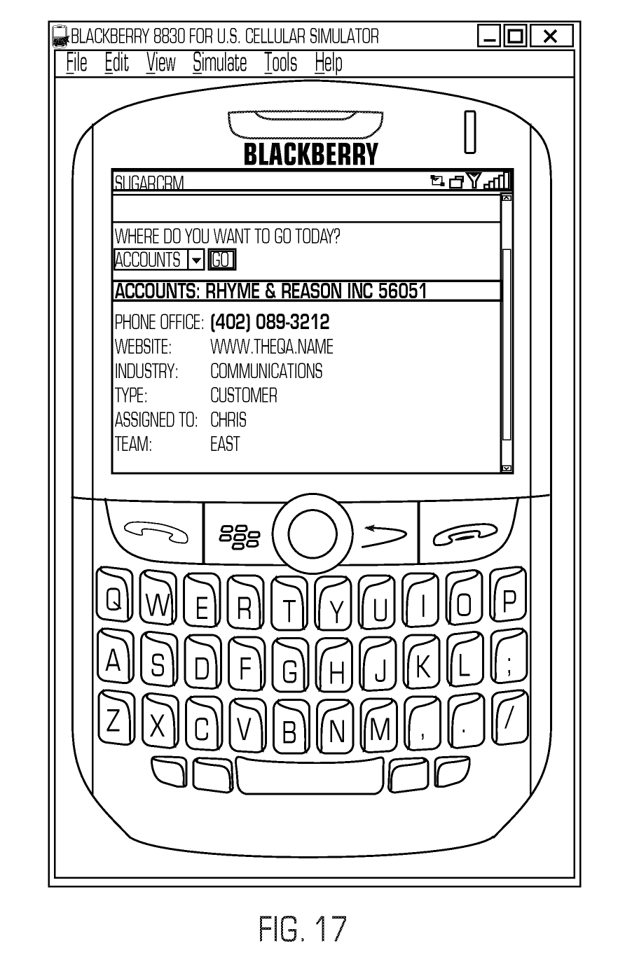

The business software application system, such as the SugarCRM application in the illustrative embodiment, may provide a rendering layer suitable for a variety of wireless devices. The architecture of the wireless engine may be based on the set of standard SugarCRM architecture components, including but not limited to: SugarCRM Metadata-Driven MVC Framework, Module System, Universal Login Authentication, Studio Customization Support, etc. The rendering layer may provide views (including detail and edit) into SugarCRM native and custom modules as shown in FIGS. 11-17 that illustrate a wireless version of the business software application system displayed on a wireless device. All of the wireless views include a navigation menu and logout in a footer.

The wireless component's flexible rendering layer may provide automated conversions of user interface elements and context for the screen size and dimensions of the target mobile device. The system may auto-detect device specific parameters, including device type, browser type, connection speed, etc. to establish an optimal target setting to optimize for the target environment. The minimum detection criterion may include the type of the device to ensure that every mobile device receives a page rendered for a hand-held system.

The security and authentication for the wireless component may be provided by the core set of the SugarCRM security components. The system, therefore, may provide the following baseline functionality, including:
Honor ACL/Roles and Teams security
Redirect to Login page on un-authenticated request.
Verification of sessions upon login
Logout after inactivity
Do not allow mobile view on desktop browser

The system may also include further extensions to the wireless component that enable the user to customize and further configure specific application parameters that may be applicable too this component:
Enable or Disable Wireless
Set number of records per list view

The wireless interface may also provide upload/download and sync functionality to allow users to maintain their CRM data consistent throughout their use of the CRM application and regardless of the end-device. Some of these features may include:
Data synchronization (this may include address books, calendars, emails, etc)
vCard upload and download
SMS input to send or edit module data
Mobile dashlets and quickview interface for the handheld

While the foregoing has been with reference to a particular embodiment of the invention, it will be appreciated by those skilled in the art that changes in this embodiment may be made without departing from the principles and spirit of the invention, the scope of which is defined by the appended claims.

1. A business software application system, comprising:
a computing device with a processing unit;
a business software application having a plurality of lines of computer code wherein the plurality of lines of computer code are executed by the processing unit of the computing device to generate a user interface of the business software application; and
the business software application further comprising a tracker unit that is capable of tracking one of records and user actions.

2. The system of claim 1 further comprising a database containing a plurality of pieces of information, one or more modules that access the database to pull pieces of information from the database based on a request from the computing device and display a user interface to the user containing the requested information; one or more controllers that control access by the computing device to the one or more modules and the database and wherein the one or more modules further comprises a tracker module.

3. The system of claim 1, wherein the tracker unit maps actions and navigation history of a user of the business software application.

4. The system of claim 2, wherein the tracker unit performs auditing of records stored in the database.

5. The system of claim 1, wherein the tracker unit generates a tracker log.

6. The system of claim 1, wherein the tracker unit performs resource management of the business software application.

7. The system of claim 6, wherein the tracker unit generates an alert when a threshold limit of a resource of the business software application is reached.

8. The system of claim 7, wherein the resource further comprises one or more of the processing unit, a memory unit of the computing device, a database connection to the database and a socket.

9. A business software application system, comprising:
a computing device with a processing unit;
a business software application having a plurality of lines of computer code wherein the plurality of lines of computer code are executed by the processing unit of the computing device to generate a user interface of the business software application; and
the business software application further comprising a security unit that is capable of providing security to an external form of the business software application.

10. The system of claim 9 further comprising a database containing a plurality of pieces of information, one or more modules that access the database to pull pieces of information from the database based on a request from the computing device and display a user interface to the user containing the requested information; one or more controllers that control access by the computing device to the one or more modules and the database and wherein the one or more modules further comprises a security module that provides security to an external form of the business software application.

11. The system of claim 9, wherein the security unit generates a unique password for each external form.

12. The system of claim 9, wherein the security unit generates a time based rotating key for each external form.

13. A business software application system, comprising:
a computing device with a processing unit;
a business software application having a plurality of lines of computer code wherein the plurality of lines of computer code are executed by the processing unit of the computing device to generate a user interface of the business software application;
a database containing a plurality of pieces of information;
one or more modules that access the database to pull pieces of information from the database based on a request from the computing device and display a user interface to the user containing the requested information; and
the one or more modules further comprising a module builder that allow users to build a new layout, field, feature, page or sub-application of the business software application.

14. The system of claim 13, wherein the module builder further comprises a relationship editor that allows a user to one of view, create, modify and delete an entity relationship in the business software application.

15. The system of claim 13, wherein the one or more modules further comprises an import module to import data into the business software application.

16. The system of claim 15, wherein the import module generates one or more waves wherein each wave processes a portion of the imported data.

17. The system of claim 13, wherein the one or more modules further comprises a reports module having a reports wizard to read or write a report and a reports runner unit to read or run a report.

18. The system of claim 13, wherein the one or more modules further comprises a charts module that generates charts associated with the business software application.

19. The system of claim 13, wherein the one or more modules further comprises a wireless engine having a rendering layer to generate a user interface of the business software application for different wireless devices.
